(19) United States
(12) Patent Application Publication
(10) Pub. No.: US 2026/0358983 A1
(43) Pub. Date: Nov. 12, 2026

(54) HARD DRIVE CONTROL APPARATUS AND METHOD, DEVICE, NONVOLATILE READABLE STORAGE MEDIUM, AND SERVER

(71) Applicant: SUZHOU METABRAIN INTELLIGENT TECHNOLOGY CO., LTD., Suzhou, Jiangsu (CN)

(72) Inventor: Lianxing QIU, Suzhou, Jiangsu (CN)

(21) Appl. No.: 19/131,666

(22) PCT Filed: May 22, 2023
(86) PCT No.: PCT/CN2023/095609

§ 371 Date: May 21, 2025

(30) Foreign Application Priority Data
Nov. 24, 2022 (CN) 202211482036.9

(51) Int. Cl. G06F 3/06

(52) U.S. Cl. CPC G06F 3/0676; G06F 3/0604; G06F 3/0655

(57) ABSTRACT

A hard disk control apparatus includes a plurality of hard disk connectors, an expansion connector connected to each of the hard disk connectors, and an expansion card plugged into the expansion connector. And the expansion card has a same form factor as a hard disk, the expansion connector is connected to a server through a cable; the expansion connector is configured to receive a hard disk control signal transmitted from the server through the cable; and the expansion card is configured to expand the hard disk control signal into a plurality of signals and transmit the plurality of signals to each of the hard disk connectors to control an operating state of the hard disk plugged into each of the hard disk connectors.

### CROSS-REFERENCE TO RELATED APPLICATION

This disclosure is a 371 application of International Application No. PCT/CN2023/095609, filed on May 22, 2023, which claims the priority of the Chinese Patent application filed on Nov. 24, 2022 before the CNIPA, China National Intellectual Property Administration with the application number of 202211482036.9, and the title of “HARD DRIVE CONTROL APPARATUS AND METHOD, DEVICE, NONVOLATILE READABLE STORAGE MEDIUM, AND SERVER”, which is incorporated herein in its entirety by reference.

### FIELD

The present disclosure relates to the technical field of computers, in particular to a hard disk control apparatus and method, a device, a non-transitory readable storage medium, and a server.

### BACKGROUND

Currently, expansion cards for hard disk expansion in a server are located inside a server chassis, which are connected to a server motherboard and each of hard disks outside the server chassis through corresponding cables. In this configuration, both the expansion cards and the corresponding cables may occupy confined chassis space. Moreover, the expansion card is a vulnerable module, and replacing the expansion card requires shutting off a server power supply and removing a chassis cover, thereby leading to inconvenient maintenance.

Consequently, how to provide an easy-to-maintain hard disk expansion solution is a problem that necessitates resolution by persons skilled in the art.

### SUMMARY

In view of this, the present disclosure aims to provide a hard disk control apparatus and method, a device, a non-transitory readable storage medium, and a server to provide an easy-to-maintain hard disk expansion solution. A specific solution is provided below:

In a first aspect, the present disclosure provides a hard disk control apparatus, including a plurality of hard disk connectors, an expansion connector connected to each of the hard disk connectors, and an expansion card plugged into the expansion connector, wherein the expansion card has a same form factor as hard disks;
the expansion connector is connected to a server through a cable;
the expansion connector is configured to receive a hard disk control signal transmitted from the server through the cable; and
the expansion card is configured to expand the hard disk control signal into a plurality of signals and transmit the plurality of signals to each of the hard disk connectors to control an operating state of the hard disk plugged into each of the hard disk connectors.

In some embodiments, the apparatus further includes:
a detection circuit connected to each of the hard disk connectors and the expansion connector, wherein
correspondingly, the detection circuit is configured to detect an operating state of a device plugged into each of the connectors to which the detection circuit is connected, and the connectors include the hard disk connector and the expansion connector.

In some embodiments, the apparatus further includes:
a power supply module connected to each of the hard disk connectors and the expansion connector, wherein
the power supply module is configured to supply power to each of the hard disk connectors and the expansion connector.

In some embodiments, the expansion connector is connected to the power supply module through a first enable control module; and
correspondingly, the first enable control module is configured to control powering-off of the expansion connector when the expansion card is plugged off from the expansion connector, and to control powering-on of the expansion connector when the expansion card is plugged into the expansion connector.

In some embodiments, the expansion connector is connected to the power supply module through a physical switch; and
correspondingly, the physical switch is configured to control powering-off or powering-on of the expansion connector under user operations.

In some embodiments, any one of the hard disk connectors is connected to the power supply module through a second enable control module; and
correspondingly, the second enable control module is configured to control powering-off of the corresponding hard disk connector when the hard disk is plugged off from the corresponding hard disk connector, and to control powering-on of the corresponding hard disk connector when the hard disk is plugged into the corresponding hard disk connector.

In some embodiments, an expansion chip in the expansion card is an expander chip, a serial attached small computer system interface (SCSI) (SAS) chip, or a redundant arrays of independent disk (RAID) chip.

In some embodiments, in response to that the expansion chip is an expander chip, the expansion connector is connected to an SAS card or a RAID card in the server through the cable.

In some embodiments, each of the hard disk connectors and the expansion connector are each provided with a device status indicator light.

In some embodiments, a plurality of expansion connectors are provided.

In some embodiments, modules in the hard disk control apparatus are connected through a backplane.

In a second aspect, the present disclosure provides a hard disk control method, the hard disk control method is applied to the hard disk control apparatus according to any one of the first aspect, the hard disk control apparatus includes a plurality of hard disk connectors, an expansion connector connected to each of the hard disk connectors, and an expansion card plugged into the expansion connector, the expansion card having a same form factor as a hard disk, and the expansion connector is connected to a server through a cable; and
the hard disk control method includes the following steps:
when the expansion connector receives a hard disk control signal transmitted from the server through the cable, the expansion card expands the hard disk control signal into a plurality of signals and transmits the plurality of signals to each of the hard disk connectors to control an operating state of the hard disk plugged into each of the hard disk connectors.

In some embodiments, the hard disk control signal includes a read/write signal, a configuration signal, and/or an alarm signal.

In some embodiments, in response to that the hard disk control signal is a read/write signal, when the expansion connector receives the read/write signal transmitted from the server through the cable, the expansion card expands the read/write signal into a plurality of signals and transmits the plurality of signals to each of the hard disk connectors to control a read/write operation of the hard disk plugged into each of the hard disk connectors.

In some embodiments, in response to that the hard disk control signal is the configuration signal, when the expansion connector receives the configuration signal transmitted from the server through the cable, the expansion card expands the configuration signal into a plurality of signals and transmits the plurality of signals to each of the hard disk connectors for completing a configuration of the hard disk plugged into each of the hard disk connectors.

In some embodiments, in response to that the hard disk control signal is the alarm signal, when the expansion connector receives the alarm signal transmitted from the server through the cable, the expansion card expands the alarm signal into a plurality of signals and transmits the plurality of signals to each of the hard disk connectors for triggering an alarm on the hard disk plugged into each of the hard disk connectors.

In some embodiments, the apparatus further includes:
a power supply module connected to each of the hard disk connectors and the expansion connector, wherein
the power supply module is configured to supply power to each of the hard disk connectors and the expansion connector.

In some embodiments, the apparatus further includes:
a detection circuit connected to each of the hard disk connectors and the expansion connector, wherein
correspondingly, the detection circuit is configured to detect an operating state of a device plugged into each of the connectors to which the detection circuit is connected.

In some embodiments, the expansion connector is connected to the power supply module through a first enable control module; and
correspondingly, the first enable control module is configured to control powering-off of the expansion connector when the expansion card is plugged off from the expansion connector, and to control powering-on of the expansion connector when the expansion card is plugged into the expansion connector.

In some embodiments, the expansion connector is connected to the power supply module through a physical switch; and
correspondingly, the physical switch is configured to control powering-off or powering-on of the expansion connector under user operations.

In some embodiments, any one of the hard disk connectors is connected to the power supply module through a second enable control module; and
correspondingly, the second enable control module is configured to control powering-off of the corresponding hard disk connector when the hard disk is plugged off from the corresponding hard disk connector, and to control powering-on of the corresponding hard disk connector when the hard disk is plugged into the corresponding hard disk connector.

In some embodiments, an expansion chip in the expansion card is an expander chip, a serial attached small computer system interface (SCSI) (SAS) chip, or a redundant arrays of independent disk (RAID) chip.

In some embodiments, in response to that the expansion chip is an expander chip, the expansion connector is connected to an SAS card or a RAID card in the server through the cable.

In some embodiments, each of the hard disk connectors and the expansion connector are each provided with a device status indicator light.

In some embodiments, a plurality of expansion connectors are provided.

In some embodiments, modules in the hard disk control apparatus are connected through a backplane.

In some embodiments, the expansion card is provided with an anti-interference enclosure.

In a third aspect, the present disclosure provides an electronic device, including:
a memory, configured to store a computer program; and
a processor, configured to execute the computer program to implement the hard disk control method.

In a fourth aspect, the present disclosure provides a non-transitory readable storage medium, configured to store a computer program, wherein the computer program, when executed by a processor, causes the processor to implement the hard disk control method.

In a fifth aspect, the present disclosure provides a server, including the hard disk control apparatus according to any one of the first aspect, the hard disk control apparatus being disposed on an outer side wall of a chassis of the server.

In some embodiments, the apparatus includes a plurality of hard disk connectors, an expansion connector connected to each of the hard disk connectors, and an expansion card plugged into the expansion connector, the expansion card has a same form factor as a hard disk, wherein
the expansion connector is connected to a server through a cable;
the expansion connector is configured to receive a hard disk control signal transmitted from the server through the cable; and
the expansion card is configured to expand the hard disk control signal into a plurality of signals and transmit the plurality of signals to each of the hard disk connectors to control an operating state of the hard disk plugged into each of the hard disk connectors.

In some embodiments, the apparatus further includes: a detection circuit connected to each of the hard disk connectors, the expansion connector and a power supply module, wherein
correspondingly, the detection circuit is configured to detect an operating state of a device plugged into each of the connectors to which the detection circuit is connected.

In some embodiments, the expansion connector is connected to the power supply module through a first enable control module; and
correspondingly, the first enable control module is configured to control powering-off of the expansion connector when the expansion card is plugged off from the expansion connector, and to control powering-on of the expansion connector when the expansion card is plugged into the expansion connector.

In some embodiments, the expansion connector is connected to the power supply module through a physical switch; and
correspondingly, the physical switch is configured to control powering-off or powering-on of the expansion connector under user operations.

In some embodiments, any one of the hard disk connectors is connected to the power supply module through a second enable control module; and
correspondingly, the second enable control module is configured to control powering-off of the corresponding hard disk connector when the hard disk is plugged off from the corresponding hard disk connector, and to control powering-on of the corresponding hard disk connector when the hard disk is plugged into the corresponding hard disk connector.

In some embodiments, an expansion chip in the expansion card is an expander chip, a serial attached small computer system interface (SCSI) (SAS) chip, or a redundant arrays of independent disk (RAID) chip.

In some embodiments, in response to that the expansion chip is an expander chip, the expansion connector is connected to an SAS card or a RAID card in the server through the cable.

In some embodiments, each of the hard disk connectors and the expansion connector are each provided with a device status indicator light.

In some embodiments, a plurality of expansion connectors are provided.

In some embodiments, modules in the hard disk control apparatus are connected through a backplane.

As can be known from the above-mentioned solution, the present disclosure provides the hard disk control apparatus, including the plurality of hard disk connectors, the expansion connector connected to each of the hard disk connectors, and an expansion card plugged into the expansion connector, wherein the expansion card has the same form factor as the hard disks, the expansion connector is connected to the server through the cable; the expansion connector is configured to receive the hard disk control signal transmitted from the server through the cable; and the expansion card is configured to expand the hard disk control signal into the plurality of signals and transmit the plurality of expanded signals to each of the hard disk connectors to control the operating state of the hard disk plugged into each of the hard disk connectors.

The hard disk control apparatus disclosed in the present disclosure provides the expansion card in a form of the hard disk, which may be plugged into the expansion connector in a same manner as the hard disk. In this way, when needing to be replaced, the expansion card may be directly plugged off from the expansion connector without removing a server chassis cover, making maintenance easier. Therefore, the present disclosure provides an easy-to-maintain hard disk expansion solution. The hard disk control apparatus provided in the present disclosure includes the plurality of hard disk connectors, the expansion connector connected to each of the hard disk connectors, and the expansion card plugged into the expansion connector, wherein the expansion card has the same form factor as the hard disk. Moreover, the expansion connector is connected to the server through the cable; the expansion connector is configured to receive the hard disk control signal transmitted from the server through the cable; and the expansion card is configured to expand the hard disk control signal into the plurality of signals and transmit the plurality of expanded signals to each of the hard disk connectors to control the operating state of the hard disk plugged into each of the hard disk connectors. According to the present disclosure, the expansion card is transferred from the server chassis to a region where the hard disk is located, which not only may achieve hard disk control and expansion for the server, but can also reduce cabling complexity within the server chassis to save space within the server chassis, thereby offering greater flexibility for designing a high-density storage solution. Meanwhile, according to the present disclosure, the expansion card having the same form factor as the hard disk may be replaced without removing the chassis cover, facilitating implementation of hot maintenance of the expansion card.

Correspondingly, the hard disk control method, the device, the non-transitory readable storage medium, and the server provided in the present disclosure also achieve the above-mentioned technical effects.

### BRIEF DESCRIPTION OF THE DRAWINGS

In order to describe technical solutions of the embodiments of the present disclosure more clearly, the accompanying drawings used in the illustration of the embodiments will be briefly introduced. Apparently, the accompanying drawings in the following explanation illustrate merely some embodiments of the present disclosure, and those skilled in the art may obtain other accompanying drawings based on these accompanying drawings without paying any creative effort.

FIG. 1 is a schematic diagram of a hard disk control apparatus according to some embodiments of the present disclosure;

FIG. 2 is a schematic diagram of another hard disk control apparatus according to some embodiments of the present disclosure;

FIG. 3 is a schematic diagram of a pin definition of an expansion connector according to some embodiments of the present disclosure;

FIG. 4 is a schematic diagram of an operating principle of an expansion chip according to some embodiments of the present disclosure;

FIG. 5 is a schematic diagram of a connection between an expansion connector and hard disk connectors on a backplane according to some embodiments of the present disclosure;

FIG. 6 is a schematic diagram of a connection relation between an expansion chip and an expansion connector according to some embodiments of the present disclosure;

FIG. 7 is a schematic diagram of still another hard disk control apparatus according to some embodiments of the present disclosure; and

FIG. 8 is a schematic diagram of a form factor of an expansion card according to some embodiments of the present disclosure.

### DETAILED DESCRIPTION

A clear and thorough description for technical solutions in the embodiments of the present disclosure will be given below in conjunction with the accompanying drawings in the embodiments of the present disclosure. Apparently, the described embodiments are a part of embodiments of the present disclosure, not all the embodiments. All other embodiments obtained, based on the embodiments in the present disclosure, by those skilled in the art without paying creative effort fall within the protection scope of the present disclosure.

Currently, expansion cards for hard disk expansion in a server are located inside a server chassis and are connected to a server motherboard and hard disks outside the server chassis through corresponding cables. In this configuration, both the expansion cards and the corresponding cables may occupy confined chassis space. Moreover, the expansion card is a vulnerable module, and replacing the expansion card requires shutting off a server power supply and removing a chassis cover, thereby leading to inconvenient maintenance. Therefore, the present disclosure provides a hard disk control solution, which not only may achieve hard disk control and expansion for the server, but can also reduce cabling complexity within the server chassis to save space within the server chassis, thereby offering greater flexibility for designing a high-density storage solution.

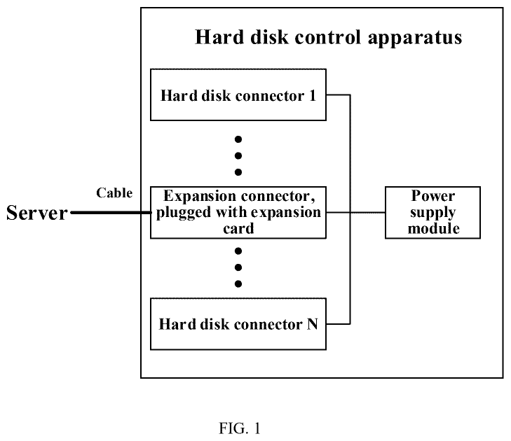

Referring to FIG. 1, an embodiment of the present disclosure discloses a hard disk control apparatus, including a plurality of hard disk connectors, an expansion connector connected to each of the hard disk connectors, an expansion card plugged into the expansion connector in a form of a hard disk, and a power supply module connected to each of the hard disk connectors and the expansion connector.

The expansion connector is connected to a server through a cable. The power supply module is configured to supply power to each of the hard disk connectors and the expansion connector; the expansion connector is configured to receive a hard disk control signal transmitted from the server through the cable; and the expansion card is configured to expand the hard disk control signal into a plurality of signals and transmit the plurality of expanded signals to each of the hard disk connectors to control an operating state of the hard disk plugged into each of the hard disk connectors.

In this embodiment, the expansion card in the form of the hard disk maintains a same form factor as the hard disk, allowing the expansion card to be hot-swappable in a same manner as the hard disk. Moreover, the expansion card is provided with an anti-interference enclosure, which may prevent electrostatic discharge and radiation, facilitating manual plugging of the expansion card. Dimensions of the anti-interference enclosure may be designed by referring to dimensions of the hard disk, for example, the dimensions of the anti-interference enclosure include, but are not limited to, 2.5 inches and 3.5 inches. The anti-interference enclosure for the expansion card generally adopts a cuboid form factor. For example, a 3.5-inch shielded enclosure has dimensions of 147 mm (L)×101.6 mm (W)×26.1 mm (H), a 2.5-inch shielded enclosure has dimensions of 100.2 mm (L)×69.85 mm (W)×14.8 mm (H). The anti-interference enclosure has the same form factor as the expansion card.

The power supply module in the hard disk control apparatus may supply power to each of the hard disk connectors and the expansion connector; the expansion connector may receive the hard disk control signal transmitted from the server through the cable; and the expansion card may expand the hard disk control signal into a plurality of signals and transmit the plurality of expanded signals to each of the hard disk connectors to control the operating state of the hard disk plugged into each of the hard disk connectors. The hard disk control signal includes a read/write signal, a configuration signal, and/or an alarm signal. Therefore, the server may perform read/write control, information configuration and/or error alarm on the plurality of hard disks by the hard disk control apparatus. The information configuration includes operations, such as hard disk upgrade and hard disk partition.

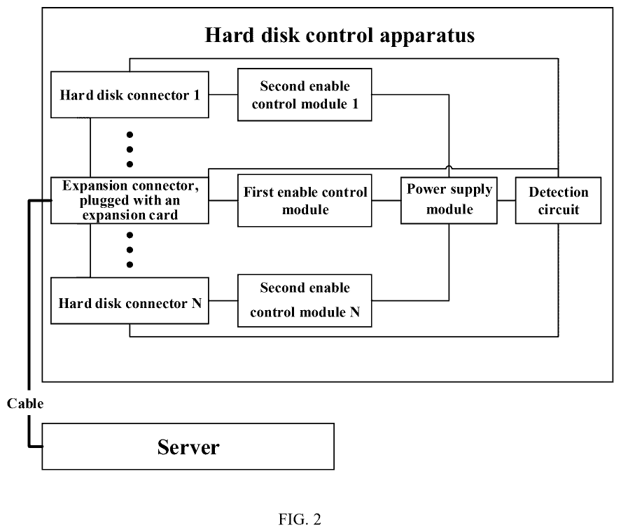

Each of the hard disk connectors and the expansion connector may be collectively referred to as connectors, and the hard disks and the expansion card which are plugged into the connectors may be collectively referred to as devices. Referring to FIG. 2, the hard disk control apparatus further includes a detection circuit connected to each of the hard disk connectors, the expansion connector, and the power supply module. Correspondingly, the detection circuit is configured to detect an operating state of the device plugged into each of the connectors to which the detection circuit is connected, i.e., detecting an in-position signal of the device plugged into each of the connectors. The detection circuit is further configured to control an on/off state or a color of a device status indicator light based on the signal reaching the corresponding connector when each of the connectors corresponds to the device status indicator light. For example, when a device that operates properly is plugged into a certain connector, the detection circuit controls a device status indicator light corresponding to the connector to remain steady-on in green. When a faulty device is plugged into a certain connector, the detection circuit controls a device status indicator light corresponding to the connector to flicker in red. Of course, a strategy table may be preset, such that the detection circuit controls the on/off state and color of the device status indicator light according to the strategy table. In a specific implementation, each of the hard disk connectors and the expansion connector are each provided with the device status indicator light. The detection circuit may be implemented based on a complex programmable logical device (CPLD), a field-programmable gate array (FPGA), and other logic circuits.

Referring to FIG. 2, the expansion connector is connected to the power supply module through a first enable control module; and correspondingly, the first enable control module is configured to control powering-off of the expansion connector when the expansion card is plugged off from the expansion connector, and to control powering-on of the expansion connector when the expansion card is plugged into the expansion connector. In such a way, hot-swapping of the expansion card may be achieved, and a hot-swappable function may be implemented with reference to a hot-swappable function of the hard disk. Of course, the expansion connector may be further connected to the power supply module through a physical switch; and correspondingly, the physical switch is configured to control the powering-off or powering-on of the expansion connector under user operations. This method is easier to implement compared to hot-swapping, as the method does not require extensive software modifications, but requires a user to manually control powering-on or powering-off of the expansion card. When operating the physical switch to power off the expansion connector and the expansion card, the user may plug off the expansion card from the expansion connector or plug the expansion card into the expansion connector; and after the expansion card is plugged into the expansion connector, the user further operates the physical switch to power on the expansion connector.

Referring to FIG. 2, any one of the hard disk connectors is connected to the power supply module through a second enable control module; and correspondingly, the second enable control module is configured to control powering-off of the corresponding hard disk connector when the hard disk is plugged off from the corresponding hard disk connector, and to control powering-on of the corresponding hard disk connector when the hard disk is plugged into the corresponding hard disk connector. In such a way, a hot-swappable function of the hard disk is achieved. Specific operations may be implemented with reference to the prior art, and are not repeated herein.

In a specific implementation, an expansion chip in the expansion card is an expander chip, a serial attached small computer system interface (SCSI) (SAS) chip, or a redundant arrays of independent disks (RAID) chip. When the expansion chip in the expansion card is an independent expander chip, the SAS chip or the RAID chip may further be disposed in the expansion card. Namely, the expansion chip in the expansion card may also be the expander chip+the SAS chip, or the expander chip+the RAID chip.

In a specific implementation, in response to that the expansion chip is an expander chip, the expansion connector is connected to an SAS card or a RAID card in the server through the cable.

In a specific implementation, the plurality of expansion connectors are provided. When the plurality of expansion connectors are disposed in the hard disk control apparatus, these expansion connectors may be respectively connected to part of the hard disk connectors in the hard disk control apparatus, whereby any one of the hard disk connectors may be connected to the at least one expansion connector. For example, in response to that the hard disk control apparatus is provided with 2 expansion connectors (expansion connector A and an expansion connector B), and 8 hard disk connectors 1 to 8, the expansion connector A is connected to the hard disk connectors 1 to hard disk connectors 4, while the expansion connector B is connected to the hard disk connectors 5 to hard disk connectors 8. Of course, the expansion connector A and the expansion connector B may be further connected to the 8 hard disk connectors simultaneously, whereby the expansion cards which are plugged into the expansion connector A and the expansion connector B, respectively may serve as backups for each other. As a result, expansion card selection logic needs to be designed to determine which expansion card controls each hard disk on the specific hard disk connector. The expansion card selection logic may be implemented in a software program in the expansion chip, and may be further implemented in the detection circuit through a selector circuit.

In a specific implementation, modules in the hard disk control apparatus are connected through a backplane. As a result, a circuit connection relation may be simplified, making the hard disk control apparatus easier to implement.

The hard disk control apparatus in this embodiment provides the expansion card in the form of the hard disk, which may be plugged in a same manner as the hard disk. When needing to be replaced, the expansion card may be directly plugged off from the expansion connector without removing a server chassis cover. Accordingly, this embodiment provides an easy-to-maintain hard disk expansion solution. This solution not only achieves hard disk control and expansion for the server, but also reduces cabling complexity within a server chassis to save space within the server chassis, thereby offering greater flexibility for designing a high-density storage solution.

The following describes a hard disk control method provided by an embodiment of the present disclosure. A hard disk control method described below may be cross-referenced with the hard disk control method described above.

The hard disk control method disclosed in the embodiment of the present disclosure is applied to the hard disk control apparatus of the embodiment. The hard disk control apparatus includes a plurality of hard disk connectors, an expansion connector connected to each of the hard disk connectors, an expansion card plugged into the expansion connector in a form of a hard disk, and a power supply module connected to each of the hard disk connectors and the expansion connector, wherein the expansion connector is connected to a server through a cable. The expansion card has a same form factor as the hard disk.

According to the hard disk control method disclosed in the embodiment of the present disclosure, under a condition that the power supply module supplies power to each of the hard disk connectors and the expansion connector, the expansion connector receives a hard disk control signal transmitted from the server through the cable; the expansion card expands the hard disk control signal into a plurality of signals and transmits the plurality of expanded signals to each of the hard disk connectors to control an operating state of the hard disk plugged into each of the hard disk connectors.

In a specific implementation, the hard disk control signal includes a read/write signal, a configuration signal, and/or an alarm signal. In one example, the hard disk control method specifically includes: The expansion connector receives the hard disk read/write signal transmitted from the server through the cable; the expansion card expands the hard disk read/write signal into a plurality of signals and transmits the plurality of expanded signals to each of the hard disk connectors to control a read/write operation of the hard disk plugged into each of the hard disk connectors.

In one example, the hard disk control method specifically includes: the expansion connector receives the hard disk configuration signal transmitted from the server through the cable; and the expansion card expands the hard disk configuration signal into a plurality of signals and transmits the plurality of expanded signals to each of the hard disk connectors to control configurations, such as upgrade and partition, of the hard disk plugged into each of the hard disk connectors.

In one example, the hard disk control method specifically includes: the expansion connector receives the hard disk alarm signal transmitted from the server through the cable; and the expansion card expands the hard disk alarm signal into a plurality of signals and transmits the plurality of expanded signals to each of the hard disk connectors to perform error alarm for the hard disk plugged into each of the hard disk connectors.

In this embodiment, the hard disk control apparatus further includes a detection circuit connected to each of the hard disk connectors, the expansion connector, and the power supply module; and correspondingly, the detection circuit is configured to detect an operating state of a device plugged into each of the connectors to which the detection circuit is connected.

In this embodiment, the expansion connector is connected to the power supply module through a first enable control module; and correspondingly, the first enable control module is configured to control powering-off of the expansion connector when the expansion card is plugged off from the expansion connector, and to control powering-on of the expansion connector when the expansion card is plugged into the expansion connector.

In this embodiment, the expansion connector is connected to the power supply module through a physical switch; and correspondingly, the physical switch is configured to control the powering-off or powering-on of the expansion connector under user operations.

In this embodiment, any one of the hard disk connectors is connected to the power supply module through a second enable control module; and correspondingly, the second enable control module is configured to control powering-off of the corresponding hard disk connector when the hard disk is plugged off from the corresponding hard disk connector, and to control powering-on of the corresponding expansion connector when the hard disk is plugged into the corresponding hard disk connector.

In this embodiment, an expansion chip in the expansion card is an expander chip, an SAS chip or a RAID chip. In response to the expansion chip as the expander chip, the expansion connector is connected to an SAS card or a RAID card in the server through the cable.

In this embodiment, each of the hard disk connectors and the expansion connector are each provided with a device status indicator light. In a specific implementation, the plurality of expansion connectors are provided. In a specific implementation, modules in the hard disk control apparatus are connected through a backplane.

This embodiment provides a hard disk control method. Based on the solution, read/write, alarm, and other operations may be controlled conveniently for each of the hard disks in the server. The hard disk control apparatus applied herein provides the expansion card in the form of the hard disk, which may be plugged in the same manner as the hard disk. When needing to be replaced, the expansion card may be directly plugged off from the expansion connector without removing a server chassis cover. Accordingly, this embodiment provides an easy-to-maintain hard disk expansion solution. This solution not only achieves hard disk control and expansion for the server, but also reduces cabling complexity within a server chassis to save space within the server chassis, thereby offering greater flexibility for designing a high-density storage solution.

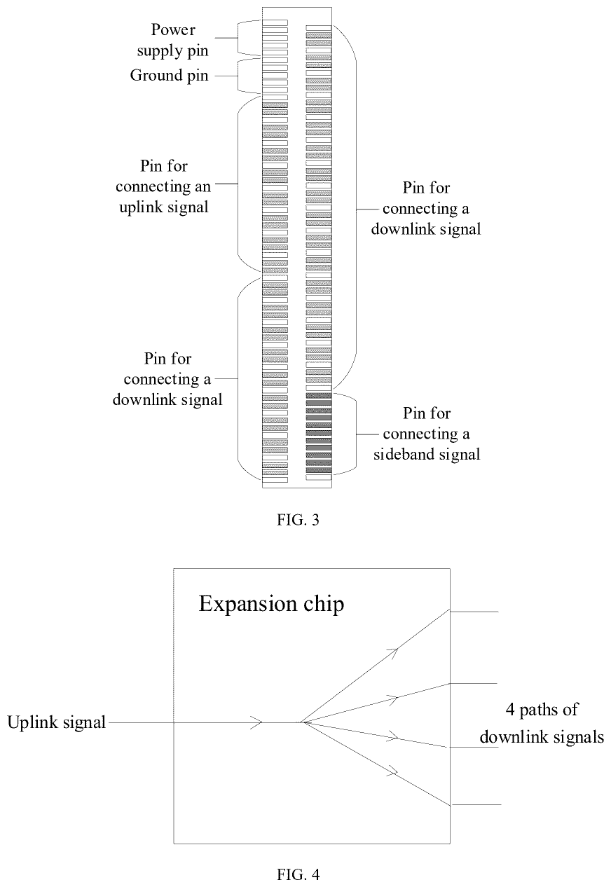

Based on the above-mentioned embodiment, it should be noted that in order to maximize a number of expandable hard disks, a connector with a higher pin density may be selected as the expansion connector. Each pin in the expansion connector may be defined by referring to FIG. 3. As shown in FIG. 3, the expansion connector is defined with a power supply pin, a ground pin, a pin for connecting an uplink signal and an isolation ground, a pin for connecting a downlink signal and an isolation ground, and a pin for connecting a sideband control signal. The uplink signal is a signal transmitted from the server, while the downlink signal is a signal transmitted to each of the hard disk connectors. The more pins for connecting the downlink signals indicate a greater number of the expandable hard disks.

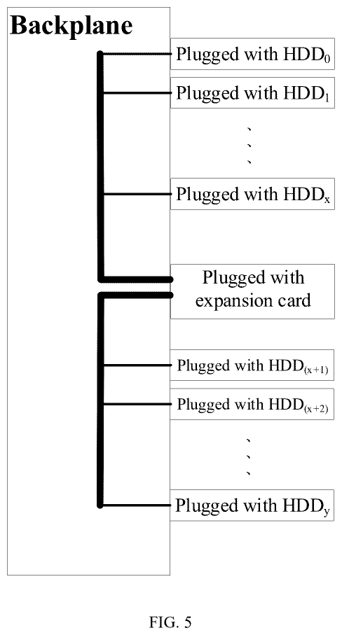

The power supply pin may supply power to the expansion chip and a peripheral circuit on the expansion card. The expansion chip may be selected from chips such as the SAS chip and the expander chip according to requirements. The expansion chip expands a small number of uplink signals into more downlink signals, which are then transmitted into each of the hard disk connectors, thereby achieving an objective of hard disk expansion. As shown in the FIG. 4, a path of uplink signal may be transformed into 4 paths of downlink signals through the expansion chip.

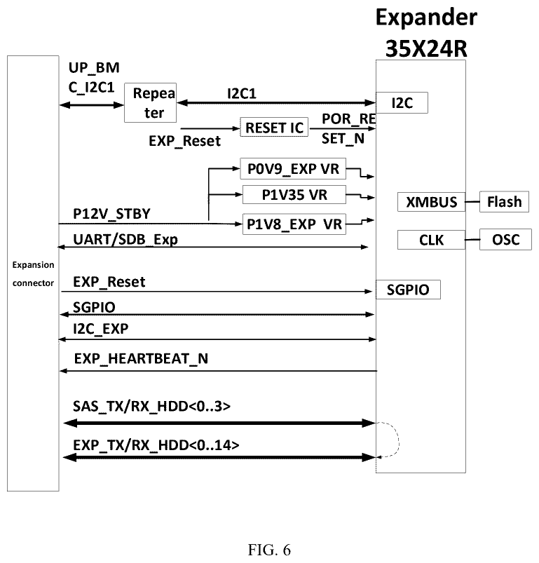

To simplify a circuit relation in the hard disk control apparatus, the modules such as the hard disk connectors and the expansion connector may be disposed on the backplane, thereby facilitating circuit connection through the backplane. As shown in FIG. 5, the backplane is provided with a plurality of hard disk connectors and one expansion connector. A hard disk drive (HDD) is plugged into each of the hard disk connectors, while the expansion card is plugged into the expansion connector. Meanwhile, all hard disk connectors are connected to the expansion connector through circuits. The expansion card may be plugged into the backplane in the same manner as the hard disk, thereby justifying the designation that the expansion card in the present disclosure is in the form of the hard disk. The expansion card has the same maintenance advantage as the hard disk, and may be replaced without removing the chassis cover. Of course, referring to a hot-swappable function of the hard disk, hot swapping of the expansion card may be achieved, thereby achieving hot maintenance of the expansion card. Since the expansion card is disposed on the backplane, the space within the chassis is freed up, which is more convenient for cable routing within the chassis. This, in turn, enables a design of a high-density storage solution. The expansion card has the same form factor as the hard disk.

In one example, a specific connection relation between the expansion chip and the expansion connector may be referred to FIG. 6. In FIG. 6, LSISAS35x24R is selected as the expansion chip. SAS signals over 4i, SAS_TX/RX_HDD<0 . . . 3>, are introduced through the expansion connector to the LSISAS35x24R expansion chip. After expansion by the LSISAS35x24R expansion chip, SAS signals over 15i, EXP_TX/RX_HDD<0 . . . 14>, are obtained. The SAS signals over 15i are transmitted to each of the hard disk connectors through the expansion connector. A normal operation of the expansion chip also requires to be supported by other signals, such as I2C, POR_RESET_N, as shown in FIG. 6. For specific details, please refer to a user manual of the LSISAS35x24R expansion chip.

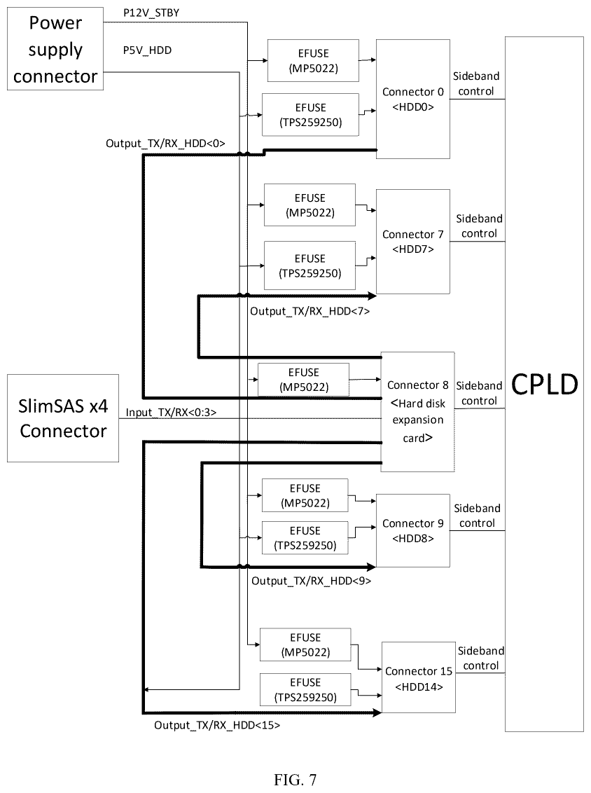

In one example, as shown in FIG. 7, one backplane may be designed with 16 connectors, wherein connectors 0-7 and connectors 9-15 are the hard disk connectors, and an HDD disk is plugged into each of the hard disk connectors. A connector 8 is the expansion connector. Meanwhile, the backplane may be configured with a slimSAS x4 connector for uplink cable access. The connector receives the SAS signals over 4i and transmits the SAS signals to the hard disk expansion card through the backplane. After the expansion by the expansion chip on the expansion card, signals over 15 lanes are obtained. The signals over 15 lanes are then transmitted through the connector 8 and printed circuit board (PCB) routing on the backplane to the hard disk connectors 0-7 and the hard disk connectors 9-15. A power supply connector for connecting a power supply is further disposed on the backplane. In FIG. 7, EFUSE is an enable controller, and CPLD is a detection circuit. The CPLD is configured to detect an in-position signal of the hard disk or the expansion card and control an on/off state of the corresponding indicator light. An uplink only carries x4 high-speed signals, with only one x4 lane for high-speed routing. However, through the expansion of the expansion card, downlink signals over 15 lanes may be obtained, thereby achieving hard disk expansion.

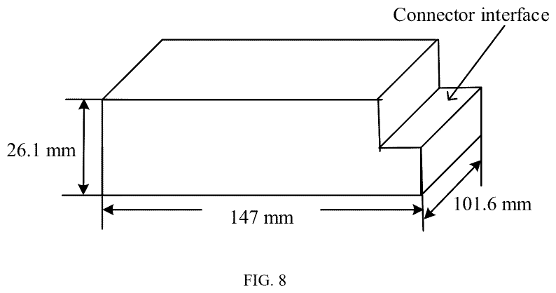

The ground pin of the expansion connector is designed as a long pin for the CPLD to conveniently control the EFUSE, thereby achieving the hot-swappable function of the expansion card. Moreover, the expansion card is provided with an anti-interference enclosure, which may prevent electrostatic discharge and radiation, facilitating manual plugging of the expansion card. Dimensions of the anti-interference enclosure may be designed by referring to dimensions of the hard disk, for example, the dimensions of the anti-interference enclosure include, but are not limited to, 2.5 inches and 3.5 inches. The anti-interference enclosure of the expansion card generally adopts a cuboid form factor. For example, a 3.5-inch anti-interference enclosure has dimensions of 147 mm (L)×101.6 mm (W)×26.1 mm (H). The anti-interference enclosure has the same form factor as the expansion card. The 3.5-inch expansion card may be referenced in FIG. 8, in which a metal pin is disposed in a connector interface for being connected to the expansion connector. Of course, the anti-interference enclosure for the expansion card may also take other form factors resembling that of the hard disk.

In summary, according to the present disclosure, a number of the cables inside the chassis may be reduced, and the expansion of the number of the hard disks may be implemented, thereby offering greater flexibility for designing the high-density storage solution. Moreover, the expansion card is in the form of the hard disk, which may be maintained without removing the chassis cover, thereby facilitating implementation of hot maintenance of the expansion card. After standardizing the form factor and pin definition of the hard disk expansion card, the expansion card may be more flexible to replace, thereby supporting different applications. Of course, the expansion connectors may be disposed additionally on the backplane as needed to achieve the higher-density storage solution.

The higher-density storage solution involves allowing more hard disks to be plugged into the server, thereby increasing a hard disk density. For example, 60, 72, or 100 hard disks may be configured under space of the server with 4U in height, thereby achieving various storage densities. Under the condition that a density of the hard disk increases, an increase in a density of the cables is caused inevitably. Since the server chassis space is confined, the number of the cables inside the chassis may be reduced by the present disclosure, thereby easily implementing large-capacity storage in the confined space.

The following describes an electronic device provided by an embodiment of the present disclosure. An electronic device described below may be cross-referenced with the hard disk control method and apparatus described above.

The embodiment of the present disclosure discloses an electronic device, including
a memory, configured to store a computer program; and
a processor, configured to execute the computer program to implement the method disclosed in any one of the above-mentioned embodiments.

The following describes a non-transitory readable storage medium provided by an embodiment of the present disclosure. The non-transitory readable storage medium described below may be cross-referenced with the hard disk control method and apparatus, and the device described above.

The non-transitory readable storage medium is configured to store a computer program, wherein the computer program, when executed by the processor, causes the processor to implement the hard disk control method disclosed in the above-mentioned embodiments.

The following describes a server provided by an embodiment of the present disclosure. The server described below may be cross-referenced with the hard disk control method and apparatus described above.

The embodiment of the present disclosure discloses a server, including the hard disk control apparatus in any one of the above-mentioned embodiments. The hard disk control apparatus is disposed on an outer side wall of a server chassis to implement hot swapping of an expansion card and hard disks.

In a specific implementation, the hard disk control apparatus includes a plurality of hard disk connectors, an expansion connector connected to each of the hard disk connectors, an expansion card plugged into the expansion connector in a form of a hard disk, and a power supply module connected to each of the hard disk connectors and the expansion connector, wherein the expansion connector is connected to a server through a cable; under a condition that the power supply module supplies power to each of the hard disk connectors and the expansion connector, the expansion connector receives a hard disk control signal transmitted from the server through the cable; the expansion card expands the hard disk control signal into a plurality of signals and transmits the plurality of expanded signals to each of the hard disk connectors to control an operating state of the hard disk plugged into each of the hard disk connectors. The expansion card has a same form factor as the hard disk.

In a specific implementation, the hard disk control apparatus further includes a detection circuit connected to each of the hard disk connectors, the expansion connector, and the power supply module; and correspondingly, the detection circuit is configured to detect an operating state of a device plugged into each of the connectors to which the detection circuit is connected.

In a specific implementation, the expansion connector is connected to the power supply module through a first enable control module; and correspondingly, the first enable control module is configured to control powering-off of the expansion connector when the expansion card is plugged off from the expansion connector, and to control powering-on of the expansion connector when the expansion card is plugged into the expansion connector.

In a specific implementation, the expansion connector is connected to the power supply module through a physical switch; and correspondingly, the physical switch is configured to control the powering-off or powering-on of the expansion connector under user operations.

In a specific implementation, any one of the hard disk connectors is connected to the power supply module through a second enable control module; and correspondingly, the second enable control module is configured to control powering-off of the corresponding hard disk connector when the hard disk is plugged off from the corresponding hard disk connector, and to control powering-on of the corresponding hard disk connector when the hard disk is plugged into the corresponding hard disk connector.

In a specific implementation, an expansion chip in the expansion card is an expander chip, an SAS chip or a RAID chip. In response to that the expansion chip is an expander chip, the expansion connector is connected to an SAS card or a RAID card in the server through the cable.

In a specific implementation, each of the hard disk connectors and the expansion connector are each provided with a device status indicator light.

In a specific implementation, the plurality of expansion connectors are provided.

In a specific implementation, modules in the hard disk control apparatus are connected through a backplane.

Further, the server provided in the embodiment of the present disclosure specifically includes at least one processor, at least one memory, a power supply, a communication interface, an input/output interface, and a communication bus, wherein the memory is configured to store a computer program, and the computer program is loaded and implemented by the processor.

In this embodiment, the power supply is configured to provide an operating voltage for hardware devices on the server; the communication interface is configured to create a data transmission channel between the server and peripheral devices, and a communication protocol that the communication interface follows is any communication protocol that is applicable to a technical solution of the present disclosure, which is not specifically limited herein; and the input/output interface is configured to receive input data from the peripheral devices or output data to the peripheral devices, and a specific interface type may be selected according to the specific application requirements, which is not specifically limited herein.

Additionally, the memory, as a carrier for storing resources, may be a read-only memory, a random access memory, a disk, an optical disk, or the like. The resources stored in the memory include an operating system, a computer program, data, and so on, and a storage method may be either temporary or permanent storage.

The operating system is configured to manage and control each of the hardware devices and the computer program on the server, enabling the processor to perform operations and processing on data stored in the memory. The operating system may be Windows Server, Netware, Unix, Linux, or other operating systems. The computer program may be a computer program that is configured to complete other specific works. In addition to including data such as a virtual machine, the data may also include information about a developer of the virtual machine, and other data.

Further, the server provided by the embodiment of the present disclosure may be in communication with a terminal. Specifically, the terminal may include, but is not limited to, a smartphone, a tablet computer, a notebook computer, a desktop computer, and so on.

Generally, the terminal may include the processor and the memory.

The processor may include one or a plurality of processor cores, such as a 4-core processor and an 8-core processor. The processor may be implemented by using at least one hardware form from digital signal processing (DSP), a field-programmable gate array (FPGA), and a programmable logic array (PLA). The processor may further include a main processor and a co-processor. The main processor, also referred to as a central processing unit (CPU), is configured to process data in a wakeup state; and the co-processor is a low-power processor configured to process data in a standby state. In some embodiments, the processor may be integrated with a graphics processing unit (GPU), wherein the GPU is configured to render and draw content to be displayed on a display screen. In some embodiments, the processor may further include an artificial intelligence (AI) processor, wherein the AI processor is configured to process machine learning-related computations.

The memory may include one or a plurality of non-transitory readable storage medium, wherein the non-transitory readable storage medium may be non-transient. The memory may further include a high-speed random access memory and a non-transitory memory, such as one or a plurality of disk storage devices or flash memory devices. In this embodiment, the memory is at least configured to store the computer program. Additionally, the resources stored in the memory may further include the operating system, the data, etc., and the storage method may be either the temporary or permanent storage. The operating system may include Windows, Unix, Linux, or other operating systems. The data may include, but is not limited to, updated information on an application program.

In some embodiments, the terminal may further include a display screen, an input/output interface, a communication interface, a sensor, a power supply, and a communication bus.

The terms “first,” “second,” “third,” “fourth,” etc. (if any) mentioned in this disclosure are used to distinguish similar objects and are not necessarily intended to describe a specific order or sequence. It should be understood that the data used in this manner may be interchanged under appropriate circumstances, so that the embodiments described herein may be implemented in orders other than those illustrated or described herein. Furthermore, the terms “comprising,” “including,” “having,” and any variations thereof are intended to cover non-exclusive inclusions. For example, a process, method, or device that includes a series of steps or units is not necessarily limited to those steps or units explicitly listed, but may include other steps or units that are not explicitly listed or are inherent to such processes, methods, or devices.

It should be noted that the descriptions involving “first,” “second,” etc., in this disclosure are for illustrative purposes only and should not be construed as indicating or implying relative importance or implicitly specifying the quantity of the indicated technical features. Thus, features defined by “first” or “second” may explicitly or implicitly include at least one such feature. Additionally, the technical solutions of various embodiments may be combined with one another, provided that such combinations may be realized by a person of ordinary skill in the art. If the combination of technical solutions results in contradictions or proves unfeasible, such a combination shall be deemed non-existent and falls outside the scope of protection claimed in this disclosure.

The embodiments in this specification are described in a progressive manner, with each embodiment focusing on the differences from other embodiments. For identical or similar parts between the embodiments, cross-reference may be made accordingly.

The steps of the methods or algorithms described in connection with the embodiments disclosed herein may be implemented directly in hardware, in software modules executed by a processor, or in a combination of both. The software modules may reside in random access memory (RAM), main memory, read-only memory (ROM), electrically programmable ROM (EPROM), electrically erasable programmable ROM (EEPROM), registers, hard disks, removable disks, CD-ROMs, or any other form of non-transitory readable storage medium known in the technical field.

This document illustrates the principles and implementations of the present disclosure through specific examples. The descriptions of the above embodiments are intended solely to facilitate understanding of the methods and core concepts of this disclosure. Moreover, persons skilled in the art may, based on the ideas presented herein, make modifications to specific implementations and applications. Accordingly, the content of this specification should not be construed as limiting the scope of the present disclosure.

1. A hard disk control apparatus, comprising a plurality of hard disk connectors, an expansion connector connected to each of the hard disk connectors, and an expansion card plugged into the expansion connector, the expansion card has a same form factor as a hard disk, wherein
the expansion connector is connected to a server through a cable;
the expansion connector is configured to receive a hard disk control signal transmitted from the server through the cable; and
the expansion card is configured to expand the hard disk control signal into a plurality of signals and transmit the plurality of signals to each of the hard disk connectors to control an operating state of the hard disk plugged into each of the hard disk connectors.

2. The hard disk control apparatus according to claim 1, further comprising:
a detection circuit connected to each of the hard disk connectors and the expansion connector, wherein
correspondingly, the detection circuit is configured to detect an operating state of a device plugged into each of the connectors to which the detection circuit is connected, and the connectors comprise the hard disk connector and the expansion connector.

3. The hard disk control apparatus according to claim 1, further comprising:
a power supply module connected to each of the hard disk connectors and the expansion connector, wherein
the power supply module is configured to supply power to each of the hard disk connectors and the expansion connector.

4. The hard disk control apparatus according to claim 3, wherein
the expansion connector is connected to the power supply module through a first enable control module; and
correspondingly, the first enable control module is configured to control powering-off of the expansion connector when the expansion card is plugged off from the expansion connector, and to control powering-on of the expansion connector when the expansion card is plugged into the expansion connector.

5. The hard disk control apparatus according to claim 3, wherein
the expansion connector is connected to the power supply module through a physical switch; and
correspondingly, the physical switch is configured to control powering-off or powering-on of the expansion connector under user operations.

6. The hard disk control apparatus according to claim 3, wherein
any one of the hard disk connectors is connected to the power supply module through a second enable control module; and
correspondingly, the second enable control module is configured to control powering-off of the corresponding hard disk connector when the hard disk is plugged off from the corresponding hard disk connector, and to control powering-on of the corresponding hard disk connector when the hard disk is plugged into the corresponding hard disk connector.

7. The hard disk control apparatus according to claim 1, wherein an expansion chip in the expansion card is an expander chip, a serial attached small computer system interface (SCSI) (SAS) chip, or a redundant arrays of independent disk (RAID) chip.

8. The hard disk control apparatus according to claim 7, wherein in response to that the expansion chip is an expander chip, the expansion connector is connected to an SAS card or a RAID card in the server through the cable.

9. The hard disk control apparatus according to claim 1, wherein each of the hard disk connectors and the expansion connector are each provided with a device status indicator light.

10. The hard disk control apparatus according to claim 9, wherein the detection circuit is further configured to control an on/off state or a color of the device status indicator light corresponding to the connectors based on the hard disk control signal reaching each of the connectors.

11. The hard disk control apparatus according to claim 1, wherein a plurality of expansion connectors are provided.

12. The hard disk control apparatus according to claim 11, wherein the plurality of expansion connectors are respectively connected to part of the hard disk connectors in the hard disk control apparatus, whereby any one of the hard disk connectors is connected to at least one expansion connector.

13. The hard disk control apparatus according to claim 1, wherein modules in the hard disk control apparatus are connected through a backplane.

14. The hard disk control apparatus according to claim 1, wherein the expansion card is provided with an anti-interference enclosure.

15. A hard disk control method, wherein
the hard disk control method is applied to the hard disk control apparatus according to claim 1, the hard disk control apparatus comprises a plurality of hard disk connectors, an expansion connector connected to each of the hard disk connectors, and an expansion card plugged into the expansion connector, the expansion card having a same form factor as a hard disk, and the expansion connector is connected to a server through a cable; and
the hard disk control method comprises the following steps:
when the expansion connector receives a hard disk control signal transmitted from the server through the cable, the expansion card expands the hard disk control signal into a plurality of signals and transmits the plurality of signals to each of the hard disk connectors to control an operating state of the hard disk plugged into each of the hard disk connectors.

16. The hard disk control method according to claim 15, wherein the hard disk control signal comprises a read/write signal, a configuration signal, and/or an alarm signal.

17. The hard disk control method according to claim 16, wherein in response to that the hard disk control signal is a read/write signal, when the expansion connector receives the read/write signal transmitted from the server through the cable, the expansion card expands the read/write signal into a plurality of signals and transmits the plurality of signals to each of the hard disk connectors to control a read/write operation of the hard disk plugged into each of the hard disk connectors.

18. The hard disk control method according to claim 16, wherein in response to that the hard disk control signal is the configuration signal, when the expansion connector receives the configuration signal transmitted from the server through the cable, the expansion card expands the configuration signal into a plurality of signals and transmits the plurality of signals to each of the hard disk connectors for completing a configuration of the hard disk plugged into each of the hard disk connectors.

19. The hard disk control method according to claim 16, wherein in response to that the hard disk control signal is the alarm signal, when the expansion connector receives the alarm signal transmitted from the server through the cable, the expansion card expands the alarm signal into a plurality of signals and transmits the plurality of signals to each of the hard disk connectors for triggering an alarm on the hard disk plugged into each of the hard disk connectors.

20-21. (canceled)

22. A server, comprising the hard disk control apparatus according to claim 1, the hard disk control apparatus being disposed on an outer side wall of a chassis of the server.
